(19) United States
(12) Patent Application Publication
(10) Pub. No.: US 2022/0281183 A1
(43) Pub. Date: Sep. 8, 2022

(54) EXPANSION HELD PREPEG COMPOSITE

(71) Applicant: Gosakan ARAVAMUDAN, Bangalore (IN)

(72) Inventor: Gosakan ARAVAMUDAN, Bangalore (IN)

(21) Appl. No.: 17/630,896

(22) PCT Filed: Jul. 29, 2020
(86) PCT No.: PCT/IN2020/050666

§ 371 Date: Jan. 27, 2022

(30) Foreign Application Priority Data
Jul. 31, 2019 (IN) 201941030847

(51) Int. Cl. B29C 70/34; B29C 70/56

(52) U.S. Cl. CPC B29C 70/342; B29C 70/56

(57) ABSTRACT

In the expansion held prepeg composite (100) disclosed herein, using a flexible and expandable tubular core (101), one or more set of fibers are linearly placed over the circumference of the tubular core (101); and one or more set of fibers with predetermined tensions are wound over the linear fibers to create an expansion held prepeg composite (100). At least one of the set of fibers is precoated with resin. The tension of wrapping of each subsequent set of fibers is higher than its precedent wound layer. A bladder tube is inserted into the tubular core (101) of the expansion held prepeg composite 100. The expansion held prepeg composite (100) is a held in the desired three dimensional shape. Compressed air is introduced into the bladder tube and cured. At least one of the sets of fiber must be impregnated with resin.

### CROSS-REFERENCE TO RELATED APPLICATIONS

This application is a PCT application that claims priority to and the benefit of the provisional patent application titled “Expansion held prepeg ropes”, application number 201941030847, filed in the Indian Patent Office on Jul. 31, 2019. The specification of the above referenced patent application is incorporated herein by reference in its entirety.

### BACKGROUND

This invention in general relates to manufacturing composites, and specifically relates to the restrained prepeg curing of composites.

A prepeg is preimpregnated fibrous material used to make reinforced plastics. In order to manufacture curved composite three dimensional structures, such as complex curved composite tubes, complex molds are required. In the current art, multiple discrete prepegs are cut and placed around a mandrel or bladder and placed in complex molds, and air pressure is internally applied to consolidate the composite during heat cure. Prepegs are fibers coated with resin, capable of providing long shelf life upon freezer storage and eventually being high temperature cured in a mold.

The aforementioned current approach has many disadvantages as listed below.

Firstly, the prepegs used in most molds use discrete cut pieces, hence it lacks strength resulting from loss of fiber continuity, especially around corners, edges and nodes of structures.

Secondly, discrete prepeg cutting is a multistep time consuming, machine and/or labour intensive process. Prepegs in rolled up sheet form need to purchased and stored in −15 Celsius cold storage units. They need to be brought out of the freezer and brought to room temperature. They are then cut into pre-defined shapes either by hand or by a CNC machine.

Thirdly, the placement of the aforementioned cut prepegs in the mold is a high risk process. They need to be placed individually, maintaining the fiber orientation of each piece with respect to the mold. Placing the prepeg in the mold at an incorrect angle of fiber orientation may result in structural weak spots, and in some cases result in catastrophic failure during field use.

Fourthly, in some cases for complex shapes, for a length of for example 10 ft, as many as 200 pieces of cut pieces of prepegs would need to be accurately positioned. This is a time consuming process and may take hours to accomplish.

Hence, there is a long felt unresolved need to manufacture curved composite three dimensional structures using a predictable quality process resulting in a high strength product with continuous fibers, less risky, less manual and less time consuming.

### SUMMARY OF THE INVENTION

The expansion held prepeg composite disclosed herein addresses the above long felt unresolved need to manufacture curved composite three dimensional structures using a predictable quality process resulting in a high strength product with continuous fibers, less risky, and less manual and less time consuming.

In the expansion held prepeg composite disclosed herein, using a flexible and expandable tubular core, one or more set of fibers are linearly placed over the circumference of the tubular core; and one or more set of fibers with a predetermined tensions are wrapped over the linear fibers to create an expansion held prepeg composite. At least one of the set of fibers is precoated with resin. Most importantly, the tension of wrapping of each subsequent set of fibers is higher than its precedent layer.

Advantageously, the expansion held prepeg composites provides fiber continuity, and hence even around bending corners there is fiber continuity established. Fiber continuity results in a significant strength advantages in bends, junctions and corners of composite structures.

Advantageously, the expansion held prepeg composite can be easily handled as a continuous flexible tube and can be positioned into complex shapes simply by holding in three dimensional shapes by a few holders or positioners. Complex molds are not required for shape forming.

Advantageously, the expansion held prepeg composite reduces structural risk by providing a predictable machine made internal prepeg structural construction in its cross section.

Advantageously, the expansion held prepeg composite significantly reduces the time required for prepeg positioning prior to cure when compared to conventional cut piece prepegs.

### BRIEF DESCRIPTION OF THE DRAWINGS:

The foregoing summary, as well as the following detailed description of the invention, is better understood when read in conjunction with the appended drawings. For illustrating the invention, exemplary constructions of the invention are shown in the drawings. However, the invention is not limited to the specific components disclosed herein. The description of a component referenced by a numeral in a drawing is applicable to the description of that component shown by that same numeral in any subsequent drawing herein.

FIG. 1 illustrates a side view of the multilayer peeled cross section of the expansion held prepeg composite.

FIG. 2 illustrates a cross section of the expansion held prepeg composite.

FIG. 3 illustrates a top view of the apparatus for manufacturing the expansion held prepeg composite.

FIG. 4 illustrates a side view of the apparatus for manufacturing the expansion held prepeg composite.

FIG. 5 illustrates the method of manufacturing the expansion held prepeg composite.

### DETAILED DESCRIPTION OF THE INVENTION:

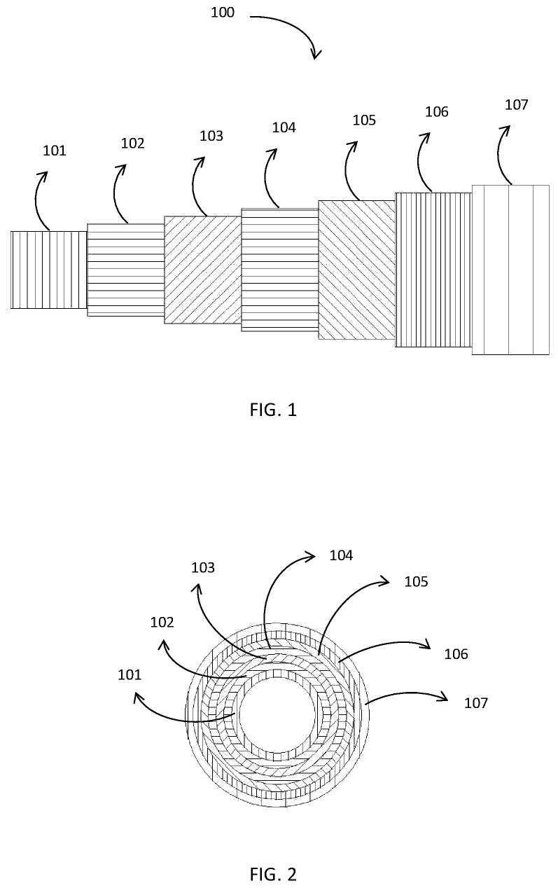

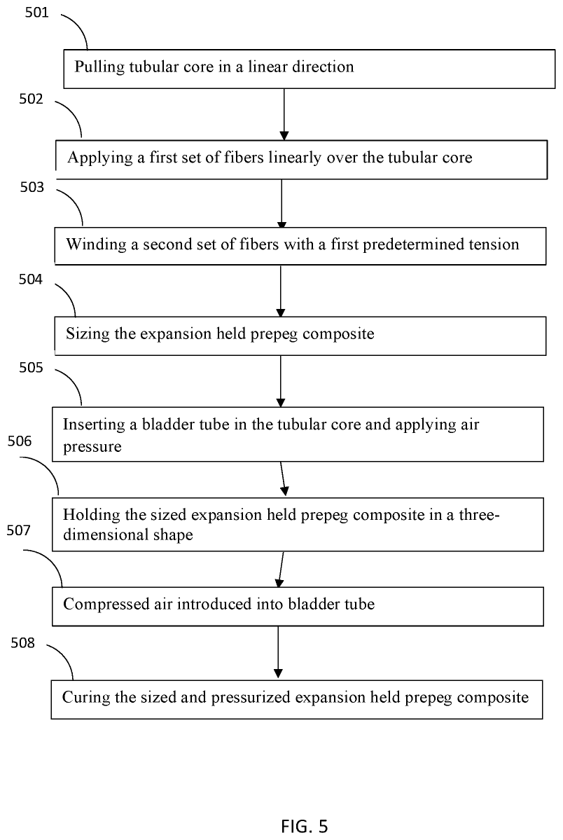

FIG. 1 illustrates a multilayer peeled cross section of the expansion held prepeg composite 100. FIG. 2 illustrates the method of manufacturing the expansion held prepeg composite 100. FIG. 5 illustrates the method of manufacturing the expansion held prepeg composite. A flexible and expandable tubular core 101 is fed linearly through guides 501. It is pulled in a in a linear direction. The tubular core 101 maintains its sectional shape without deformation while being pulled. A first set of fibers 102 is placed linearly over the circumference of the tubular core 100 as the tubular core 100 is pulled linearly 502. A second set of fibers 103 is wound over the first set 102 of linear fibers 503 with a first predetermined tension over the first set 102 of linear fibers to create an expansion held prepeg composite 100. At least one of said first set of fibers 102 or the second set of fibers 103 is precoated with resin. The expansion held prepeg composite 100 is sized to predetermined lengths 504. A bladder tube (not shown) is inserted 505 into the tubular core 101 of the expansion held prepeg composite 100. The expansion held prepeg composite 100 is a held in the desired three dimensional shape 506. Compressed air is introduced into the bladder tube 507. The expansion held prepeg composite 100 with internal compressed air is then cured in an oven 508. At least one of the sets of fiber must be impregnated with resin, this resin will transfer to other layers as well. After curing, the bladder tube and tubular core are removed. The lightweight tubular core may be sacrificially left behind.

Exemplarily, the tubular core 101 is a flexible plastic pipe, thin walled silicone tube or other flexible walled material that has the capability to expand when heated and air pressure is internally applied. Exemplarily, the bladder tube is a silicone tube or other type of expandable rubber tube. Examples of fibers preferably include carbon, glass, boron, aramid; and may also include metallic wires. Examples of resins preferably include epoxy, polyester, phenolic and other binding systems used in composites.

Composite structures preferably use multiaxial fibers in multiple directions to provide sufficient bending strength, and to avoid localized buckling. In a multiaxial expansion held prepeg composite 100, a plurality of linear and differentially angled wound fibers are provided. In this case, a third set of fibers 104 are linearly applied over said wound second set of fibers 103. A fourth set of fibers 105 are wound at a second predetermined tension level over the third set 104 of fibers of. The second predetermined tension is greater than said first predetermined tension level. A set of linear fibers may be introduced between each set of wound fibers. The linear fibers are angled at 0 degrees along the axis of pull, while the wound fibers may be at +45, −45, +60, −60, +30, −30 or other suitable multiaxial angles. At least one of the sets of fibers must be impregnated with sufficient resin, this resin will transfer to other layers as well. Preferably, all the linear fibers are impregnated with resin, and the resin from the prepeg linear fibers transfer to the neighboring wound layers during curing and compaction consolidation.

The following example illustrates the method and product of manufacture of the expansion held prepeg composite 100. A plastic pipe 101 is pulled linearly through guides. A first set of 12K carbon fiber rovings 102 are rolled out from spools, wet in an epoxy resin bath, excess resin removed and linearly guided through Teflon guides, and placed uniformly onto the circumference of the plastic pipe 101 at an angle of 0 degree along the axis of the plastic pipe 101. A second set of dry 12K carbon fibers 103 originating from rotating reels wind carbon fiber over the first set of carbon fibers at an angle of +45 degree. A third set of 12K carbon fiber rovings 104 are rolled out from spools, wet in an epoxy resin bath, excess resin removed, linearly guided through Teflon guides, and placed uniformly onto the circumference of the wound second set of carbon fibers. A fourth set 105 of dry 12K carbon fibers 105 originating from rotating reels wind carbon fiber over the first set of carbon fibers at an angle of −45 degree. A fifth set 106 of dry 12K carbon fibers placed in rotating reels wind carbon fiber over the fourth set of carbon fibers at an angle of 90 degree hoop wind angle. A final thin polyester tape 107 is wrapped over the fifth set of fibers. The winding tension of polyester tape>fifth set of fibers>fourth set of fibers>second set of fibers.

Most importantly, when a multiplicity of wound fibers are wound over one or more of earlier set of fibers, the tension level of each subsequent wound fiber is always higher than its preceding wound layer. This ensures that when internal air pressure is applied inside the expandable tubular core 101, all the fiber layers placed internally are pushed out against the final layer of wound fibers that defines the final circumferential compression shape.

A fifth set of fibers 106 placed in rotating reels wind fiber over the fourth set of carbon fibers at an angle of 90 degree hoop wind angle. For convenient handling, and to provide a fine outer finish, a final layer of plastic tape 107 is wrapped as a final layer, ensuring that the tension of the wrapped plastic tape is higher than the underlying tension of the winding of the underlying wound fiber layers 103, 105, 106 and 107.

If a high temperature resin system is used, the final step of curing is accomplished in a high temperature curing oven. The sized expansion held prepeg composite 100 is rolled up and conveniently stored in a freezer prior to curing. If a room temperature resin is used, the curing step must be performed immediately after production of the expansion held prepeg composite 100.

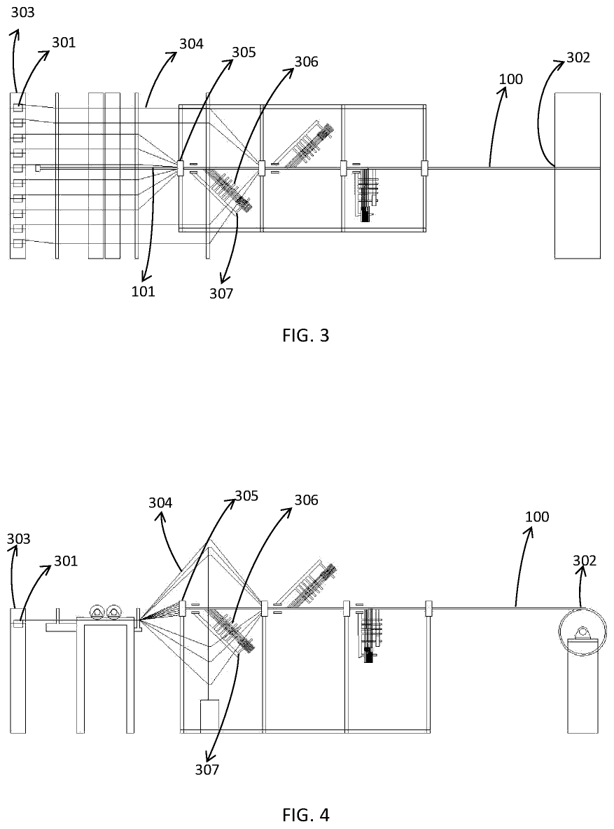

FIG. 3 illustrates a top view of the apparatus for manufacturing the expansion held prepeg composite 100. FIG. 4 illustrates a side view of the apparatus for manufacturing the expansion held prepeg composite 100. Rollers 301 are used to store and roll out the flexible and expandable tubular core 101. A pulling means 302, such as a rope wound pull on a motorized drum is attached to one end of the tubular core 101 and pulls it in a linear direction through guides in a linear direction at preprogrammed speeds. The tubular core 101 maintains its sectional shape without deformation while being pulled. Fibers wound on fiber spools are fed from a rack 303. Using fiber guides 305, the fiber rovings 304 are applied linearly in a uniform density over the circumference of the tubular core 101 as the tubular core 101 is pulled linearly. A first winder 307 winds a second set of fibers 103 with a first predetermined tension over the first set of linear fibers 102 to create an expansion held prepeg composite 100. At least one of the first set of fibers 102 or second set of fibers 103 is precoated with resin. A fiber tension adjuster 306 coupled to the fiber winder 305 applies predetermined fiber tension. A sizer cuts (not shown) the expansion held prepeg composite 100 to predetermined lengths.

If an expandable tubular core is not used, and approximately 90 degree hoop fibers or other obliquely angled fibers are wound directly on linear fibers, an expansion held prepeg rope is produced. The prepeg rope comprises fibers in a resin matrix, such as carbon fiber or glass fiber in a B staged epoxy resin matrix. The hoop yarn may be one of Aramid, carbon or glass that holds prepeg rope from expanding diametrically. Alternative fibers and resin systems may be used. The expansion held prepeg ropes are arranged in parallel and create prepeg sheets that may be stacked one upon the other at different relative angles and cured using a vacuum bag only system. The expansion held prepeg ropes may also be arranged in the form of trusses. Autoclave pressure can be substituted by a vacuum bag only system for curing prepegs using expansion held ropes. Advantageously, the expansion is withheld by the hoops and this results in a low void composite part. The circular section of the expansion held ropes will be flattened out to conform to the mold shape during cure.

The foregoing examples have been provided merely for explanation and are in no way to be construed as limiting of the system and method of manufacturing an expansion held prepeg composite disclosed herein. While the method and structure has been described with reference to particular embodiments, it is understood that the words, which have been used herein, are words of description and illustration, rather than words of limitation. Furthermore, although the method and structure has been described herein with reference to particular means, materials, and embodiments, the method and structure is not intended to be limited to the particulars disclosed herein; rather, the design and functionality of the method and structure extends to all functionally equivalent structures and uses, such as are within the scope of the appended claims. While particular embodiments are disclosed, it will be understood by those skilled in the art, having the benefit of the teachings of this specification, that the method and structure disclosed herein is capable of modifications and other embodiments may be effected and changes may be made thereto, without departing from the scope and spirit of the method and structure disclosed herein.

1. A method of manufacturing a composite, comprising the steps of:
providing a flexible and expandable tubular core;
pulling said tubular core in a linear direction, wherein said tubular core maintains its sectional shape without deformation while being pulled;
applying a first set of fibers linearly over the circumference of said tubular core as the tubular core is pulled linearly;
winding a second set of fibers with a first predetermined tension over said first set of linear fibers to create an expansion held prepeg composite, wherein at least one of said first set of fibers or second set of fibers is precoated with resin;
sizing said expansion held prepeg composite to predetermined lengths;
inserting a bladder tube in said tubular core of said sized expansion held prepeg composite; and
applying internal air pressure in said bladder tube;
holding said sized expansion held prepeg composite in a three dimensional shape; and
curing said sized expansion held prepeg composite, wherein the wound second set of fibers restrain the uncontrolled expansion of the bladder.

2. The method of claim 1, further applying a third set of fibers linearly over said wound second set of fibers.

3. The method of claim 1, further applying a fourth set of fibers wound at a second predetermined tension level over said third set of fibers of claim 2, wherein the second predetermined tension is greater than said first predetermined tension level.

4. The method of claim 1, further applying a multiplicity of wound fibers over one or more of said first set of fibers, second set of fibers, third set of fibers or fourth set of fibers, wherein the tension level of each subsequent wound fiber is higher than its preceding wound layer.

5. The method of claim 1, further applying a multiplicity of linear fibers over one or more of said first set of fibers, second set of fibers, third set of fibers or fourth set of fibers.

6. The method of claim 5, wherein said one or more of said first set of linear fibers or multiplicity of linear fibers are precoated with resin.

7. The method of claim 1, further comprising wrapping a final layer of plastic tape after all fibers have been wrapped, wherein the tension of said wrapping of plastic tape is higher than the tension of the winding of the underlying wound fiber layers.

8. The method of claim 1, wherein said step of curing is accomplished in a high temperature curing oven.

9. The method of claim 1, wherein said sized expansion held prepeg composite is stored in a freezer prior to use.

10. An expansion held prepeg composite, comprising:
a flexible and expandable tubular core;
a first set of fibers linearly placed over the circumference of said tubular core; and
a second set of fibers with a first predetermined tension over said first set of linear fibers to create an expansion held prepeg composite, wherein at least one of said first set of fibers or second set of fibers is precoated with resin.

11. The expansion held prepeg composite tube of claim 10, further comprising a third set of fibers linearly over said wound second set of fibers.

12. The expansion held prepeg composite tube of claim 10, further comprising a fourth set of fibers wound at a second predetermined tension level over said third set of fibers of claim 11, wherein the second predetermined tension is greater than said first predetermined tension level.

13. The expansion held prepeg composite tube of claim 10, further comprising a multiplicity of wound fibers over one or more of said first set of fibers, second set of fibers, third set of fibers or fourth set of fibers, wherein the tension level of each subsequent wound fiber is higher than its preceding wound layer.

14. The expansion held prepeg composite tube of claim 10, further comprising a multiplicity of linear fibers over one or more of said first set of fibers, second set of fibers, third set of fibers or fourth set of fibers.

15. The expansion held prepeg composite tube of claim 10, wherein said one or more of said first set of linear fibers or multiplicity of linear fibers are precoated with resin.

16. The expansion held prepeg composite tube of claim 10, further comprising a final layer of wrapped plastic tape over all the wound fibers, wherein the tension of said wrapping of plastic tape is higher than the tension of the winding of the underlying wound fiber layers.

17. An apparatus for method of manufacturing an expansion held prepeg composite, comprises:
rollers for rolling out a flexible and expandable tubular core;
pulling means for pulling said tubular core in a linear direction at programmed speeds, wherein said tubular core maintains its sectional shape without deformation while being pulled;
fiber spools for applying a first set of fiber rovings linearly over the circumference of said tubular core as the tubular core is pulled linearly;
a first winder for winding a second set of fibers with a first predetermined tension over said first set of linear fibers to create an expansion held prepeg composite,
wherein at least one of said first set of fibers or second set of fibers is precoated with resin;
a fiber tension adjuster coupled to said fiber winder to apply predetermined fiber tension; and
a sizer for sizing said expansion held prepeg composite to predetermined lengths;
